(19) United States
(12) Patent Application Publication
(10) Pub. No.: US 2004/0124136 A1
(43) Pub. Date: Jul. 1, 2004

(54) Apparatus and a method for treating water or other liquid material and a guide plate for use in a tube

(76) Inventor: Jorgen Bak, Bronderslev (DK)

Correspondence Address: Mark E Brown, Chase Law Firm, Suite 130, 4400 College Boulevard, Overland Park, KS, 66211, US

(21) Appl. No.: 10/475,575

(22) PCT Filed: Apr. 23, 2002
(86) PCT No.: PCT/DK02/00263

(30) Foreign Application Priority Data
Apr. 24, 2001 (DK) PA 2001 00645

(51) Int. Cl. C02F 1/00; B01F 5/06

(52) U.S. Cl. 210/512.1; 210/170; 210/512.2; 366/339

(57) ABSTRACT

An apparatus and a method for treating water or other liquid material and a guide plate for use in a tube An apparatus for treating water or other liquid material comprises a tubular element and a guide plate. The tubular element has an outer circumferential wall defining a through going passage therein and defining an inlet end and an outlet end. The guide plate is of an elongated configuration defining a longitudinal axe and is sidewise twisted one turn relative to the longitudinal axis. The guide plate is receivable within the passage for separating the passage into two parts for guiding water or other fluid material along the two parts of the passage from the inlet to the outlet end in one side wise turn.

The present invention relates to a novel technique of treating water or other liquid material.

In the modern society, the shortage of certain resources, such as clean fresh water has turned out to be a major problem necessitating on the one hand certain restrictions of the use of fresh water and also necessitates the utilisation of advanced techniques for rinsing fresh water due to environmental pollution etc. The novel technique according to the present invention provides an extremely simple, yet efficient means for cleaning fresh water or other liquid material or at least improving the quality of fresh water, in particular through reducing the activity of micro organisms present within the fresh water as the technique according to the present invention reduces the activity of the micro organisms, in particular algae present in water, which micro organisms would else within a fairly short period of time deteriorate the quality of the fresh water.

It is contemplated that the novel technique according to the present invention generally allows an improvement of the quality of in particular fresh water, but also liquid material, such as beverage products, e.g. soft drinks and beer, wine products, juice or similar products and dairy products. Although the physical or technical background for the surprising results which have been obtained by the use of the novel technique according to the present invention is not clear and although a clear and concise description of the physical reason for the surprising results obtained by the use of the technique according to the present invention is not at present available, it is contemplated that the novel technique according to the present invention, as supported by the numerous measuring results which have been obtained by the inventor supports the fact that the novel technique according to the present invention when used in accordance with the intentional application of the novel technique provides surprising results clearly improving the quality of the water or liquid product which has been subjected to the novel technique according to the present invention.

According to the teachings of the present invention, an apparatus for treating water or other liquid material is provided, which apparatus comprises: a tubular element having an outer circumferential wall defining a through going passage therein and defining an inlet end and an outlet end, and

a guide plate of an elongated configuration defining a longitudinal axe, said guide plate being sidewise twisted one turn relative to said longitudinal axis, and said guide plate being receivable within said passage for separating said passage into two parts for guiding water or other fluid material along said two parts of said passage from said inlet to said outlet end in one side wise turn.

The inventor has discovered a unique effect as to the quality of water or similar liquid product provided the water or liquid product be subjected to a treatment in the apparatus according to the present invention, which treatment involves the turning of the liquid flow through the apparatus one turn side wise during the passage through the apparatus according to the present invention from the inlet to the outlet. It is contemplated that the treatment of the water or other liquid material relates to the Coriolis effect due to the rotation of the earth and it is contemplated that the novel technique according to the present invention provides the surprising effect of improving the quality of the water treated by means of the apparatus according to the present invention based on a Coriolis effect compensation principle. Consequently, on the northern hemisphere, the side wise turn produced in the apparatus according to the present invention is a right turn, whereas on the southern hemisphere, the one side wise turn is a left turn.

The apparatus according to the present invention including the two basic components, a tubular element and a guide plate providing the one side wise turn may be embodied in numerous variants or alternatives and may advantageously be included in existing water supply installations, e.g. in a conventional house hold water supply appliance, a boiler, etc.

Provided the apparatus according to the present invention be integrated into an apparatus, or alternatively mounted in an existing water supply pipeline or similar installation, the tubular element is preferably provided with connectors at the inlet and outlet end for allowing the apparatus to be readily connected to the pipeline or similar installation. Provided the apparatus be used as a water supply outlet, the apparatus according to the present invention may be implemented with an inlet connector exclusively, as the outlet connector may be omitted or substituted by a conventional water outlet device, such as a water flow restrictor, a mesh or filter device etc.

Although the tubular element of the apparatus according to the present invention may be configurated in any appropriate configuration including a circular cylindrical tube, a rectangular or square tube or any other geometrically configurated tube, it is, as it is conventional within the plumbing industry, advantageous to provide the tubular element as a circular cylindrical tubular body allowing the guide plate to be produced from a simple elongated rectangular plate element, whereas, provided a different geometrical configuration of the tubular element be used, the elongated plate element has to be embodied in a more complex geometrical shape for allowing the elongated plate element to be received within the through going passage of the tubular element.

The apparatus according to the present invention is, as stated above, contemplated to be functioning on a Coriolis effect compensating principle, although this interpretation of the technical effect should not be construed in any limiting way. It is contemplated that the surprising effect of using the apparatus according to the present invention is not based on a chemical or similar material related effect and therefore, it is contemplated that the tubular element and the guide plate according to the present invention may be made from any relevant, in particular corrosion resistant material, such as metal or plastics materials, incuding iron, in particular galvanised iron, steel, stainless steel, aluminium, cupper, silver or PVS, PP, PE, ABS, POM or similar plastics material.

The tubular element and the guide plate may advantageously be made from the same material or materials for preventing any galvanic effect to originate from the juxtaposed positioning of the guide plate within the tubular element, however, for specific applications, the two components, the tubular element and the guide plate may be made from different materials, as the tubular element may be made from a metal material compatible with the exisiting pipeline and the guide plate may be made from a non-corrosive material exhibiting the advantageous property of reducing the deposition of lime, which property is a well established property of certain plastics materials as is well known within the plumbing and sanitary area.

Depending on the specific application of the apparatus according to the present invention and in this context the amount of water be passed through the two parts of the passage defined within the tubular element and guide plate received within the tubular element, the tubular element and the guide plate may accomodate varying dimensions as the tubular element may have a length of 10 cm-10 m, such as 10-20 cm, 20-30 cm, 30-40 cm, 40-50 cm, 50-60 cm, 60-70 cm, 70-80 cm, 80-90 cm, 90-100 cm, 1-2 m, 2-3 m, 3-4 m, 4-5 m, 5-6 m, 6-7 m, 7-8 m, 8-9 m or 9-10 m, similarly, the passage of the tubular element may define a diameter of 10 mm-1 m, such as 10-20 mm, 20-30 mm, 30-40 mm, 40-50 mm, 50-60 mm, 60-70 mm, 70-80 mm, 80-90 mm, 90-100 mm, 10-20 cm, 20-30 cm, 30-40 cm, 40-50 cm, 50-60 cm, 60-70 cm, 70-80 cm, 80-90 cm or 90-100 cm, and the passage of the tubular element may define a length of 5 cm-5 m, such as 5-10 cm, 10-20 cm, 20-30 cm, 30-40 cm, 40-50 cm, 50-60 cm, 60-70 cm, 70-80 cm, 80-90 cm, 90-100 cm, 1-2 m, 2-3 m, 3-4 m or 4-5 m, and the guide plate may define a length of 5 cm-5 m, such as 5-10 cm, 10-20 cm, 20-30 cm, 30-40 cm, 40-50 cm, 50-60 cm, 60-70 cm, 70-80 cm, 80-90 cm, 90-100 cm, 1-2 m, 2-3 m, 3-4 m or 4-5 m.

The present invention also relates to a separate component constituting the guide plate for use in a water or other fluid water supply tube for converting the water or fluid material guiding tube from a conventional supply tube into an apparatus according to the present invention. Consequently, the present invention also relates to a guide plate for use in a tubular water or other fluid material guiding tube, the guide plate being of an elongated configuration defining a longitudinal axis, the guide plate being side wise twisted, one turn relative to the longitudinal axis and the guide plate being receivable within the tube for separating the passage defined within the tube into two parts for guiding water or other fluid material along the two parts of the passage through the tube.

The guide plate may advantageously comprise any of the features of the apparatus discussed above according to the present invention.

Still further, the present invention relates to a method of treating water or other liquid material comprising:

providing an apparatus for treating water or other liquid material including:

a tubular element having an outer circumferential wall defining a through going passage therein and defining an inlet end and an outlet end, and

a guide plate of an elongated configuration defining a longitudinal axe, said guide plate being sidewise twisted one turn relative to said longitudinal axis, and said guide plate being receivable within said passage for separating said passage into two parts for guiding water or other fluid material along said two parts of said passage from said inlet to said outlet end in one side wise turn,

mounting said apparatus in an existing water or other liquid material supply tube and

supplying water or other liquid material through said tubular element of said apparatus for treating the water or other liquid material by guiding the water or other liquid material along said two parts of said passage from said inlet to said outlet in said one side wise turn.

The method according to the present invention may also advantageously comprise any of the features of the apparatus as discussed above according to the present invention.

The present invention is now to be further described with reference to the drawings, in which:

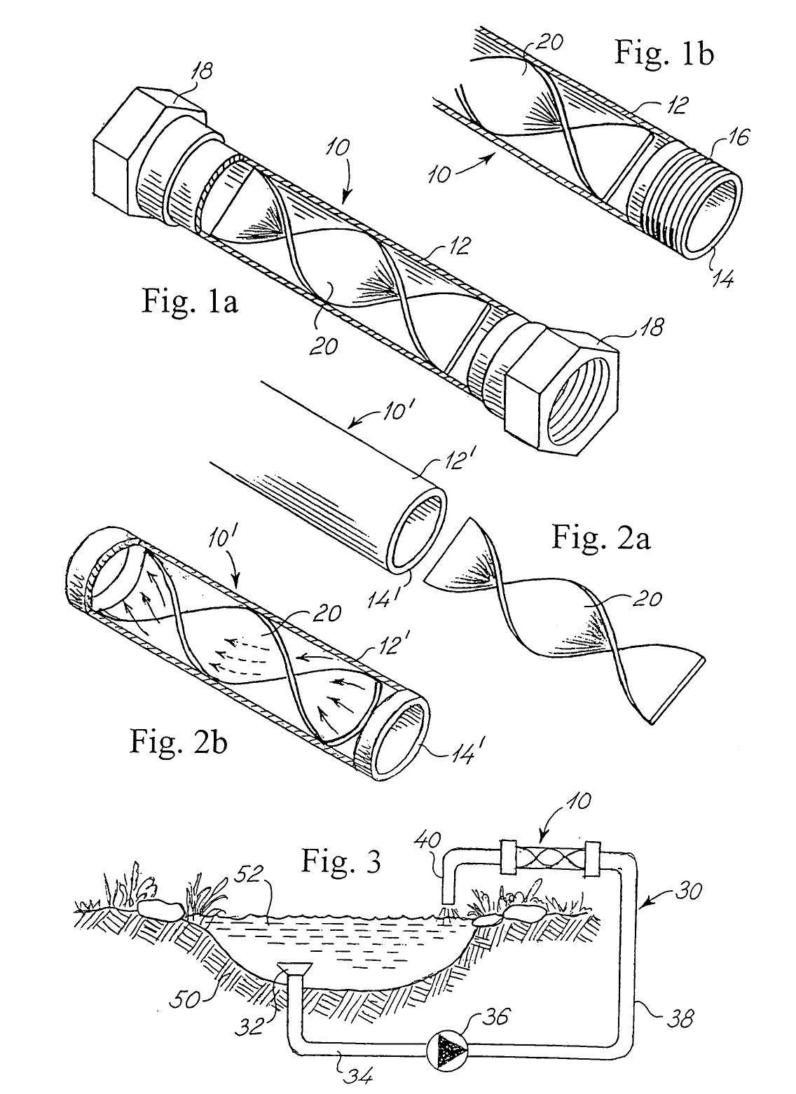

FIGS. 1a and 1b are partly sectional, perspective and schematic views of a first and presently preferred embodiment of an apparatus according to the present invention for treating water or other liquid material,

FIG. 2a is a perspective and schematic view similar to the view of FIG. 1b of a simplified or second embodiment of the apparatus according to the present invention,

FIG. 2b is a partly sectional, perspective and schematic view similar to the view of FIG. 1a of the simplified or second embodiment of the apparatus according to the present invention also shown in FIG. 2a,

FIG. 3 is a schematic view of an application of the apparatus according to the present invention for treating water of a minor lake,

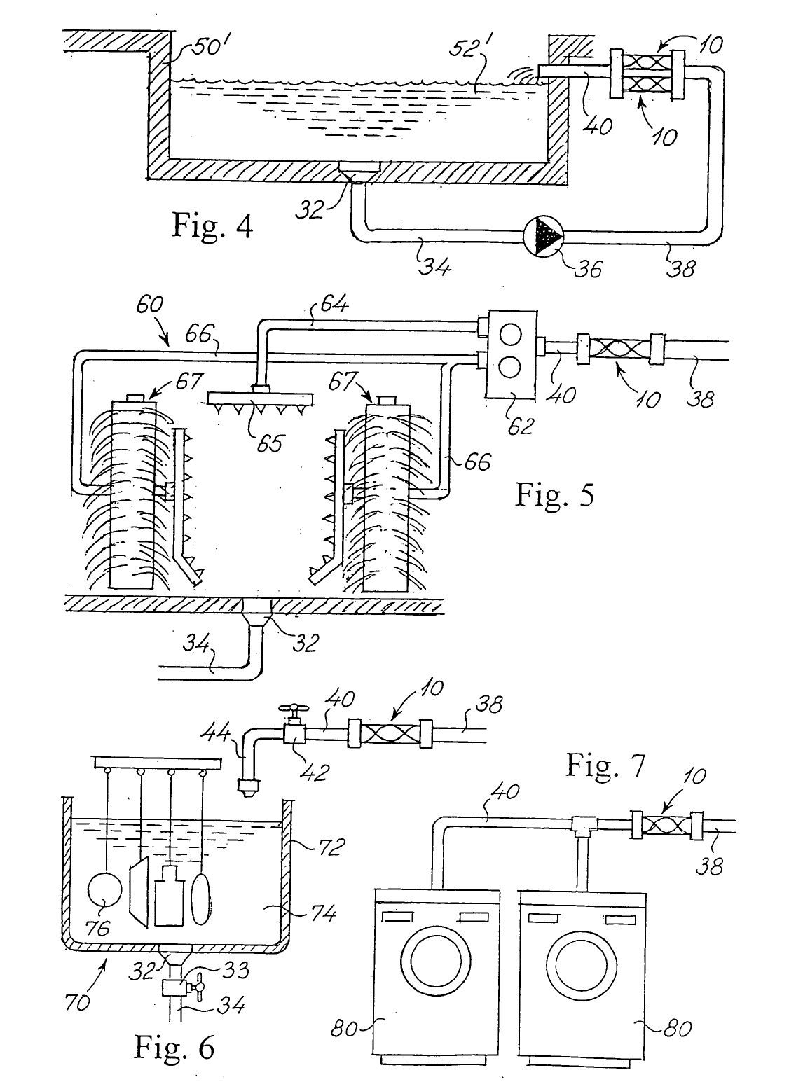

FIG. 4 is a schematic view similar to the view of FIG. 3 of an application of the apparatus according to the present invention for treating water in a swimming pool,

FIG. 5 is a schematic view illustrating the application of the apparatus according to the present invention in a car washing machine,

FIG. 6 is a schematic view of the application of the apparatus according to the present invention in an industrial plant,

FIG. 7 is a perspective view illustrating the application of the apparatus according to the present invention in a washing appliance and

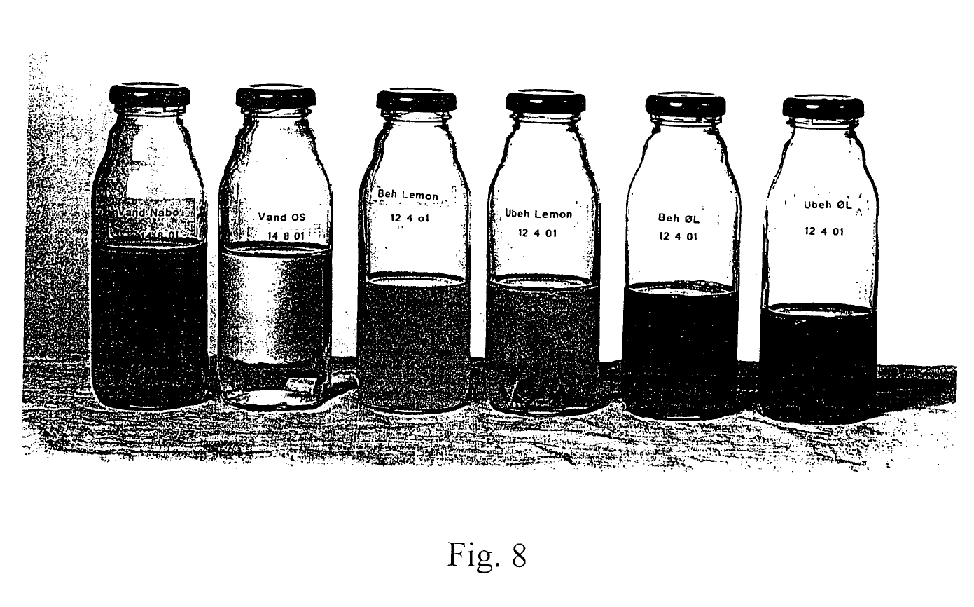

FIG. 8 is a photograph illustrating three sets of test samples proving the advantageous treating and rinsing capability of the apparatus according to the present invention.

In FIGS. 1a and 1b, a first and presently preferred embodiment of the apparatus according to the present invention for treating water or other liquid material is shown designated the reference numeral 10 in its entirety. The apparatus 10 basically comprises two main components, namely a tube 12 defining an inner through-going circular cylindrical passage and a twisted blade or plate element constituting a guide plate 20 received within the inner through going passage of the tube 12. The tube 12 is at opposite ends, as illustrated in FIG. 1b, illustrating the one end 14 provided with outer threads 16 for co-operating with fixation nuts 18 shown in FIG. 1a for allowing the apparatus to be mounted on a conventional water supply pipe for treating water guided through the inner passage defined within the tube 12 and in doing so, providing a turning one time in a right hand turn the stream of water from the inlet end to the outlet end of the apparatus. Through the one turn of the water stream in a right hand rotation provided by the twisted blade or plate 12 defining a single right hand turn along the longitudinal direction of the plate, a surprising result is obtained. The result cannot at present be explained based on a known physical, mechanical, chemical, electromagnetic or other known relation, still based on the results which the applicant has obtained, it is contemplated that an impact on microorganisms and also possible other constituents included in the water or other liquid material being subjected to treatment in the apparatus according to the present invention is obtained. It is contemplated that the twisting one time in the right hand direction on the northern hemisphere may have some relation with the established Coriolis effect due to the rotation of the earth and therefore it is contemplated that the apparatus according to the present invention should, on the southern hemisphere be of the mirror image configuration providing a left hand twisting of the stream through the apparatus for complying with the Coriolis effect on the southern hemisphere. The relation to the Coriolis effect is at present by no means established and therefore the explanation of physical results obtained by means of the apparatus must by no means be construed limited to the Coriolis effect.

The above-described first and presently preferred embodiment of the apparatus 10 shown in FIG. 1a and FIG. 1b may obviously be modified in numerous ways for complying with specific applications depending on the actual use of the apparatus. In FIGS. 2a and 2b, a simplified or modified second embodiment of the apparatus 10 of FIGS. 1a and 1b is shown designated the reference numeral 10′ in its entirety. The second embodiment shown in FIGS. 2a and 2b basically differs from the above-described first embodiment 10 shown in FIGS. 1a and 1b in that the outer threads 16 of the tube 12 are omitted and the tube 12′ shown in FIGS. 2a and 2b constitute a straight unthreaded tube 12′ to be fixated to a supply line, e.g. a water supply line by different fixtures such as O-ring sealing fixtures well known in the art per se.

Dependent on the actual application of the apparatus according to the present invention, the apparatus may be made in different sizes and from a number of relevant materials. According to the teachings of the present invention, the one turn twisted blade or plate element 20 constitutes a separate aspect of the present invention and further the method of treating the water or other liquid materials by means of the apparatus also constitutes a separate aspect of the present invention. It is contemplated that the treating of water or other liquid material may be used in a household by simply mounting the apparatus, e.g. the first embodiment 10 shown in FIGS. 1a and 1b in a water supply line of a domestic water supply within the household. Alternatively, the apparatus according to the present invention may be used in the industry for treating liquid products such as beverage products, including soft drinks and beer or other alcoholic drinks, wine, juice products, dairy products, paste products originally present in a fluid state and to be treated in accordance with the teachings of the present invention for deactivating microorganisms, in particular algae or other biological constituents or components.

According to different applications of the present invention as is illustrated in FIGS. 3-7, the apparatus according to the present invention may be used for rinsing water or similar liquid or basic material in numerous applications including rinsing water present in a lake as is illustrated in FIG. 3, in which application the earth formation 50 defines a lake 52, from which water is pumped through the apparatus 10 according to the present invention by means of a pump 36 as the water of the lake 52 is pumped from the lake through an inlet and filter device 32 through a pump inlet tube 34 further through a pump outlet tube 38 from the pump 36 through the apparatus 10 according to the present invention and delivered from an outlet tube 40 to the lake 52.

In FIG. 4, an application similar to the application shown in FIG. 3 is illustrated as two apparatuses 10 according to the present invention are for rinsing the water present within a swimming pool 50′ defining a water reservoir 52′. In FIG. 4, the components described above as far as the pumping line and water supply line is designated the same reference numeral and the system shown in FIG. 4 apart from the application in a swimming pool rather than in a natural lake differs from the above-described application shown in FIG. 3 in that two apparatuses 10 according to the present invention are used for allowing a necessary high water supply to be obtained and in doing so obtaining a relevant high flow rate through the individual apparatus according to the present invention. In an actual application of the apparatus 10 according to the present invention in a swimming pool, a surprising result was obtained as the amount of chlorine necessary for rinsing the water of the swimming pool was reduced by 80% to no more than 20% of the previous amount of chlorine used for rinsing the water of the swimming pool before the apparatus according to the present invention was used for cleaning and treating the water of the swimming pool.

In FIG. 5, a further application of the apparatus according to the present invention is shown in which application the apparatus 10 is used in a water supply line of a car washing machine 60. The car washing machine 60 is supplied with water from the water supply line 38, 40 in which the apparatus 10 is mounted for dissipating the water through two water supply lines 64 and 66 to an overhead water delivery outlet 65 and two side washing assemblies 67, respectively. The elements of the car washing machine 60 are of basically conventional structure and no detailed and elaborated description of these elements which constitute no part of the present invention is therefore presented in the present specification. The water delivered through the tubes 64 and 66 to the overhead water delivery outlet 65 and the side washing assemblies 67 is collected by a ground water outlet 32 and guided through an outlet tube 34 to the drain or alternatively to a recycling apparatus for recycling the water to the inlet tube 38.

In FIG. 6 a further application of the apparatus according to the present invention for treating and rinsing water is illustrated. In FIG. 6, the apparatus 10 according to the present invention is mounted on a water supply tube for the supply of domestic water. The inlet and the outlet tubes described above and designated the reference numerals 38 and 40 serve the purpose of delivering water to and water from, respectively, the apparatus 10 according to the present invention. The outlet tube 40 is connected to a manually operable closing valve 42 from which the water is delivered through an outlet tube 44 to a galvanic bath of a galvanic depletion apparatus. The apparatus 70 includes a container 72 in which an electrolytic solution 74 is included into which a number of electrodes and elements or components to be electrolytically plated is immersed. An outlet 32 from the electrolytic bath communicates with the outlet tube 34 through a manually operable closing valve 33. The valves 42 and 33 may obviously be substituted by electrically controllable as is well known in the art per se and the overall description of the galvanic appliance is present only for illustrative purposes without in any way limiting the protective scope of the present invention. In an actual appliance used on a major Danish silver manufacturing plant, the cleaning and rinsing apparatus according to the present invention was used primarily in the rinsing system and surprisingly, the presence of algae was, after the introduction and use of the apparatus according to the present invention in the water rinsing system radically reduced.

In FIG. 7, a further application of the apparatus 10 according to the present invention is shown, in which application the apparatus 10 according to the present invention is used in a water supply for industrial washing machinery comprising two washing machines 80.

Numerous other applications of the apparatus according to the present invention are of course deducible and foreseeable including the use in other industries, such as the beverage industries or the production of alcoholic and non-alcoholic drinks including soft drinks, beer, juice products, dairy products, wine products, distillery products etc.

### EXAMPLE

A prototype embodiment of the apparatus 10 shown in FIGS. 1a and 1b and described above was made from the following components: The tube 12 was made from a 150 mm length ¾″ galvanic iron tube conventionally used in domestic household water supply lines. The twisted guide plate tube was made from a 2 mm thick galvanic iron plate of a width of 20 mm. The overall length of the galvanic iron plate from which the guide plate 20 was made by twisting the guide plate was 125 mm.

In FIG. 8, a photograph is presented illustrating the surprising effect of the use of the apparatus according to the present invention. Three sets of samples are illustrated in FIG. 8 and named “Vand Nabo 14 8 01”, “Vand OS 14 8 01” “Beh Lemon 12 4 01”, “Ubeh Lemon 12 4 01”, “Beh ØL 12 4 01” and Ubeh ØL 12 4 01”. The photograph was taken on Nov. 20, 2001. The three sets of samples include two water samples, the one being taken from the inventor's neighbour and the sample being named “Vand Nabo” and a sample of the water delivered from a water outlet after the treatment of the water by means of the apparatus according to the present invention. The sample is labelled “Vand OS”. These samples were made on Aug. 14, 2001. It is clear that after three months, the water subjected to the treatment by means of the apparatus according to the present invention is still clear, whereas the water not subjected to the treatment by means of the apparatus according to the present invention is clearly turbid due to the presence of algae.

The second set of test samples include lemon juice, the one sample being treated by means of the apparatus according to the present invention and labelled “Beh Lemon”, whereas the untreated sample is labelled “Ubeh Lemon”. Both samples were made on Apr. 12, 2001 and at the time of taking the photograph, some seven months later, the untreated lemon sample is clearly turbid and unpleasant looking.

A third test involved the treatment of beer on the same day as the treatment of the lemon juice and the two samples, the sample being treated by guiding beer through the apparatus according to the present invention is labelled “Beh ØL”, whereas the untreated beer sample is labelled “Ubeh ØL”. Both samples were made on Apr. 12. 2001 and some seven months later, the untreated beer is like the untreated lemon and the untreated fresh water from the neighbour's water supply unclear and non-drinkable. Contrary to the untreated samples, the treated samples which have been treated by means of the apparatus according to the present invention are after several months of storage clear and drinkable. The three sets of samples illustrated in FIG. 8 clearly demonstrate the surprising effect of treating water or other liquid material by means of the apparatus according to the present invention.

Although the present invention has been described above with reference to a number of embodiments and also specific applications, the present invention is by no means to be construed limited to the above embodiments and applications as the surprising results obtained according to the teachings of the present invention by simply subjecting water or other liquid material to a single turn right hand rotation on the northern hemisphere and as it is contemplated, a single left hand turn on the southern hemisphere, may, without deviating from the scope of the present invention, be obtained in other embodiments, appliances etc. and such embodiments and appliances which may be deduced by a person having ordinary skill in the art are therefore also to be considered part of the present invention as defined in the appending claims.

1. An apparatus for treating water or other liquid material, comprising:
a tubular element having an outer circumferential wall defining a through going passage therein and defining an inlet end and an outlet end, and
a guide plate of an elongated configuration defining a longitudinal axe, said guide plate being sidewise twisted one turn relative to said longitudinal axis, and said guide plate being receivable within said passage for separating said passage into two parts for guiding water or other fluid material along said two parts of said passage from said inlet to said outlet end in one side wise turn.

2. The apparatus according to claim 1, said side wise turn being a left turn.

3. The apparatus according to claim 1, said side wise turn being a right turn.

4. The apparatus according to any of the claims 1-3, further comprising an inlet connector and optionally and preferably an outlet connector.

5. The apparatus according to any of the claims 1-4, said tubular element being constituted by a circular cylindrical tubular body and said guide plate being made from an elongated rectangular plate element.

6. The apparatus according to any of the claims 1-5, said tubular element and said guide plate being made from metal, such as iron, galvanised iron, steel, stainless steel, aluminium, copper, silver or any corrosion resistant or non-corrosion resistant metal or a combination thereof or a plastics material, such as PVC, PP, PE, ABS, POM or the like, and said tubular element and said guide plate being made from the same material or different materials.

7. The apparatus according to any of the claims 1-6, said tubular element having a length of 10 cm-10 m, such as 10-20 cm, 20-30 cm, 30-40 cm, 40-50 cm, 50-60 cm, 60-70 cm, 70-80 cm, 80-90 cm, 90-100 cm, 1-2 m, 2-3 m, 3-4 m, 4-5 m, 5-6 m, 6-7 m, 7-8 m, 8-9 m or 9-10 m.

8. The apparatus according to any of the claims 1-7, said passage of said tubular element defining a diameter of 10 mm-1 m, such as 10-20 mm, 20-30 mm, 30-40 mm, 40-50 mm, 50-60 mm, 60-70 mm, 70-80 mm, 80-90 mm, 90-100 mm, 10-20 cm, 20-30 cm, 30-40 cm, 40-50 cm, 50-60 cm, 60-70 cm, 70-80 cm, 80-90 cm or 90-100 cm.

9. The apparatus according to any of the claims 1-8, said passage of said tubular element defining a length of 5 cm-5 m, such as 5-10 cm, 10-20 cm, 20-30 cm, 30-40 cm, 40-50 cm, 50-60 cm, 60-70 cm, 70-80 cm, 80-90 cm, 90-100 cm, 1-2 m, 2-3 m, 3-4 m or 4-5 m.

10. The apparatus according to any of the claims 1-9, said guide plate defining a length of 5 cm-5 m, such as 5-10 cm, 10-20 cm, 20-30 cm, 30-40 cm, 40-50 cm, 50-60 cm, 60-70 cm, 70-80 cm, 80-90 cm, 90-100 cm, 1-2 m, 2-3 m, 3-4 m or 4-5 m.

11. A guide plate for use in a water or other fluid material supply tube, said guide plate being of an elongated configuration defining a longitudinal axis, said guide plate being side wise twisted, one turn relative to said longitudinal axis and said guide plate being receivable within said tube for separating the passage defined within said tube into two parts for guiding water or other fluid material along said two parts of said passage through said tube.

12. The guide plate according to claim 11, said guide plate having any of the characteristics of the guide plate of the apparatus according to any of the claims 2-10.

13. method of treating water or other liquid material comprising:
providing an apparatus for treating water or other liquid material including:
a tubular element having an outer circumferential wall defining a through going passage therein and defining an inlet end and an outlet end, and
a guide plate of an elongated configuration defining a longitudinal axe, said guide plate being sidewise twisted one turn relative to said longitudinal axis, and said guide plate being receivable within said passage for separating said passage into two parts for guiding water or other fluid material along said two parts of said passage from said inlet to said outlet end in one side wise turn,
mounting said apparatus in an existing water or other liquid material supply tube and
supplying water or other liquid material through said tubular element of said apparatus for treating the water or other liquid material by guiding the water or other liquid material along said two parts of said passage from said inlet to said outlet in said one side wise turn.

14. The method according to claim 13, the apparatus used in the method having any of the characteristics of the apparatus according to any of the claims 2-10 and the guide plate having any of the characteristics of the guide plate according to claim 12.
